(19) United States
(12) Patent Application Publication
(10) Pub. No.: US 2013/0000057 A1
(43) Pub. Date: Jan. 3, 2013

(54) PREPARATION OF INDIGO-DYED COTTON DENIM FABRICS AND GARMENTS

(75) Inventor: Harrie SCHOOTS, Houston, TX (US)

(73) Assignee: CELANESE INTERNATIONAL CORPORATION, Irving, TX (US)

(21) Appl. No.: 13/537,747

(22) Filed: Jun. 29, 2012

Related U.S. Application Data
(60) Provisional application No. 61/502,953, filed on Jun. 30, 2011.

(51) Int. Cl. D06P 3/854; D03D 15/00; B32B 5/02; D06B 1/00; D06M 10/00; D06P 5/02; D04B 1/24

(52) U.S. Cl. 8/494; 28/140; 28/153; 28/168; 28/165; 442/59; 8/653

(57) ABSTRACT

Disclosed herein is the preparation of indigo-dyed cotton denim fabrics suitable for use in making cotton denim garments and other denim articles. These indigo-dyed fabrics are prepared from cotton warp yarn which has been pre-treated with an emulsion copolymer prior to being contacted with an aqueous dye liquor comprising a dispersion of an indigo dyestuff. Such copolymer-treated cotton warp yarn can be woven or knitted into cotton denim griege fabrics along with untreated cotton weft yarn. Such griege denim fabric can then be indigo-dyed using the aqueous dye liquor. Alternatively, the emulsion copolymer-treated cotton warp yarn can be indigo-dyed by contact with the aqueous dye liquor before this warp yarn is incorporated into denim fabric along with the untreated cotton weft yarn. The cotton denim fabric produced by either method has the appearance of conventional ring-dyed indigo fabrics.

### FIELD

The present development relates to the preparation of indigo-dyed cotton denim fabrics and garments. Such denim fabrics and garments have a non-uniformly colored appearance.

### BACKGROUND

Denim garments are produced from denim fabric. Denim fabric is generally a 3×1 twill woven structure where the warp yarns are indigo dyed and the weft (or filling) yarns are undyed cotton. The English cotton count (Ne) of yarns used to make denim is usually 7/1's.

The unique “salt and pepper” effect of denim is created by the dyed warp yarns mingling with undyed weft yarns. The weft is packed on the loom to be hidden on the technical back of the fabric, thus making the inside of jeans look whiter. Due to the specific nature of the end product, the indigo dyed yarns in denim must be dyed in yarn form, not as a fabric. This yarn dyeing takes (for majority of denim) two forms. Rope dyeing is the most common process. Slasher dyeing is less frequently used and is aimed mostly at higher end or smaller production lots of denim.

The dyeing procedure is designed to best apply a ring dyed effect on cotton yarns with indigo, vat and sulfur dyes. These dye classes require a reduction/oxidation potential (−mV=600 to 800) and high loading of caustic (pH approx. 12 to 13) to produce a water dispersable and cotton-substantive dyestuff. The main purpose of ring dyeing is to create a layer of dyestuff on the outside perimeter of the yarn cross section that can be removed when stonewashing or other garment washing steps are performed post dyeing. The theory is that a small quantity of dyed surface yarn is removed by pumice/enzymes/etc. which then reveals the undyed or whiter cotton beneath. This removal of color creates the “character” and wash down look which retailers and their consumers expect of denim products.

Rope dyeing is described in Schoots; U.S. Pat. No. 7,201,780; Issued Apr. 10, 2007. Yarn is gathered in “ropes” made of 300 to 400 yarns. These ropes (25 to 50 ropes/machine) are sent through a continuous rope dyeing machine made up of one circulating dye bath separated by 5 to 8 boxes. The ropes travel through the dye baths for approximately 15 to 20 seconds submerged allowing the leuco form of indigo dye to paint an outer layer of color onto the yarn. This yarn then proceeds into a “skying” segment where the leuco indigo (bright yellow) is transformed to the oxidized blue indigo with air. The process repeats up to 8 times to continue to build color yield on the perimeter of the yarn. Depth of this penetration is referred to as “pop”, which can be also controlled with manipulation of the textile auxilary chemicals in the bath, caustic (NaOH) or reducing agent such as sodium hydrosulfite, sodium borohydride/bisulfite combination.

A slasher continuous dyeing machine uses the exact same dyeing mechanism and process as rope dying, but with less yarn. Only the amount of yarn used in a creel for a loom runs through the machine (approx. 1,600 yarns wide <2 meters). This allows for more accurate creation of specific colors. This process also allows for direct placement of final yarn directly into a loom.

The delicate balance of caustic, reducing agent, indigo (and vat or sulfur topping/bottoming), time in dye bath, skying time, etc. is easily disrupted. Off quality rope dyed yarn is relatively high quantity versus other dyeing forms. Some manufacturers warehouse the different shades of resulting product with a “555 sorting” method. There are risks to this method leading to the inevitable lack of supply of one of the 555 boxes.

The variation in final color of indigo-dyed yarns and denim fabrics is remarkably broad considering that only a single type of dyestuff is used. Critical elements in final denim is “red shade” of the blue color, depth of shade, contrast, penetration, washfastness of resulting denim, crockfastness, character and hand.

Given the foregoing considerations, it would be advantageous to develop alternative methods for production of indigo-dyed denim fabrics and garments with such alternative methods providing improved consistency, reproducibility and predictability compared to the delicate indigo dyeing processes existing today. Such alternative denim preparation methods would also desirably minimize variations in final denim color due to unintended variations in depth of shade. A further advantage provided by such methods could also be the elimination of the rope dyeing process altogether, with the desired denim fabric (and garments) being dyed in batch jet or similar machines instead.

### SUMMARY

In one aspect, the present development relates to a method for preparing indigo-dyed denim fabric. In the first step of such a method, emulsion-treated warp yarn is prepared by contacting cotton yarn with a cellulose-reactive emulsion copolymer and by thereafter curing the emulsion copolymer.

In the second step of such a method, the emulsion-treated cotton warp yarn is woven or knitted into denim fabric along with untreated cotton yarn as the weft yarn. In this manner, griege denim fabric is prepared having emulsion-treated cotton warp yarn in the warp direction only.

In the third step of such a method, the griege denim fabric so prepared is contacted with an aqueous dispersion of an indigo dyestuff material. This contact with the dyestuff-containing dispersion is carried out under conditions which are sufficient to preferentially color the outer cross-sectional portions of the emulsion copolymer-treated warp yarn to a greater extent than the indigo dyestuff material colors the outer cross-sectional portions of the untreated cotton weft yarn.

This method thus provides indigo-dyed denim fabric having a non-uniformly colored appearance. In a preferred embodiment of such a method, the non-uniformly colored indigo-dyed denim fabric can be subjected to further dyeing by contacting the denim fabric with an additional dyestuff material of the indigo, vat, cationic, azoic, napthol, reactive, direct, sulfur, mordant, disperse or acid type.

In another aspect, the present development relates to an alternative method for preparing indigo-dyed denim fabric. In the first step of such an alternative method, emulsion copolymer-treated warp yarn is prepared by contacting cotton yarn with a cellulose-reactive emulsion copolymer and by thereafter curing the emulsion copolymer.

In a second step of such an alternative method, the emulsion copolymer-treated warp yarn is contacted with an aqueous dispersion of an indigo dyestuff material before the warp yarn is fashioned into fabric. Contacting of the copolymer-treated warp yarn with the dye dispersion is carried out under conditions sufficient to color the outer cross-sectional portions of the emulsion copolymer-treated warp yarn.

In a third step of such an alternative method, the emulsion copolymer-treated, colored warp yarn is woven or knitted into denim fabric along with untreated cotton yarn as the weft yarn. The denim fabric so prepared thus has emulsion copolymer-treated, colored cotton yarn in the warp direction only. This provides indigo-dyed denim fabric having a non-uniformly colored appearance.

In yet another aspect, the present development is directed to indigo-dyed cotton denim fabric comprising a plurality of cotton warp yarns and a plurality of cotton weft yarns. The cotton warp yarn of the fabric is treated with a cellulose reactive emulsion copolymer and then contacted with an aqueous dispersion of an indigo dyestuff material under conditions sufficient to color the outer cross-sectional portions of this emulsion copolymer-treated cotton warp yarn. The cotton weft yarn of the fabric is untreated prior to optional contact of this cotton weft yarn with an aqueous dispersion of indigo dyestuff material.

### DETAILED DESCRIPTION

The present development is directed to the preparation of indigo-dyed denim fabric comprising woven or knitted cotton yarn. Treatment of the cotton yarn used, such as by pretreatment and/or indigo dyeing, preparation of the denim fabric from the yarn and post-treatment of the fabric by dyeing or other operations are all described in detail as follows:

### Cotton Yarn

Cotton yarn refers to a double or multi-stranded filament made by twisting or otherwise bonding cotton staple fibers together to make a cohesive thread. Twisting fibers into yarn is, of course, the process called spinning.

The cotton staple fibers can be spun into yarn in the form of single ply or multi-plied yarns. Cotton staple fibers which form such yarns typically range from about 1.0 to about 3.0 denier per filament (dpf) and have a staple length range of from about 0.5 to 8.0 cm.

It is well known that cotton fibers can be combined with other fiber types when fashioned and used in the form of yarns. However, the best pre-treating, dyeing and fabric formation results obtained using the methods described herein are achieved when the yarns used contain no fibers other than cotton. Accordingly, yarns which are 100% cotton are preferred for use in the present method.

Cotton yarn which has been, or is to eventually be, incorporated into denim fabric in the warp direction is referred to herein as “warp yarn” or “cotton warp yarn”. Conversely, cotton yarn which has been, or is to eventually be, incorporated into denim fabric in the weft (or fill) direction is referred to herein as “weft yarn” or “cotton weft yarn”.

### Cellulose-Reactive Emulsion Copolymer

The cotton warp yarn used in the methods and fabrics herein are, prior to dyeing and incorporation into denim fabrics, contacted and treated with a selected type of cellulose-reactive emulsion copolymer. Such emulsion copolymers include those which have conventionally been used as textile finishing agents. Such emulsion copolymers include those described in detail in U.S. Patent Publication No. 2011/0005008, which is incorporated by reference herein in its entirety.

Suitable types of cellulose-reactive emulsion copolymers for use in treating the cotton warp yarn include vinyl ester-based, acrylic-based, styrene/acrylic-based and/or styrene/butadiene-based emulsion copolymers. Such copolymers typically can also contain minor amounts of cross-linking or emulsion stabilizing co-monomers. Such co-monomers can, for example, in and of themselves or in combination with external cross-linking agents, make the emulsion copolymers used herein cellulose-reactive.

One preferred type of emulsion copolymer comprises the vinyl ester-based copolymers selected from vinyl acetate-ethylene copolymers, vinyl acetate-vinyl versatate; vinyl acetate-acrylic copolymers, and combinations of these copolymer types. Vinyl acetate-ethylene (VAE) emulsion copolymers are well-known. Such VAE copolymers useful herein can comprise from about 60 wt % to about 95 wt % of vinyl acetate and from about 5 wt % to about 40 wt % of ethylene, based on total monomers therein. More preferably, VAE copolymers will comprise from about 70 wt % to about 92 wt % of vinyl acetate and from about 8 wt % to about 30 wt % of ethylene, based on total monomers therein.

Another preferred type of emulsion copolymer for use in the method herein comprises acrylic emulsion copolymers made of acrylic ester co-monomers. The alkyl acrylates that can be used to prepare the acrylic ester copolymer emulsions include alkyl acrylates and alkyl methacrylates containing 1 to 12, preferably 1 to 10 carbon atoms in the alkyl group. The polymer backbone in the acrylic ester copolymer can be either hydrophilic or hydrophobic and it can comprise polymerized soft monomers and/or hard monomers. The soft and hard monomers are monomers which, when polymerized, produce soft or hard polymers, or polymers in between. Preferred soft acrylic ester monomers are selected from alkyl acrylates containing 2 to 8 carbon atoms in the alkyl group and include ethyl acrylate, propyl acrylate, n-butyl acrylate, and 2-ethylhexyl acrylate. The hard acrylic ester monomers are selected from alkyl methacrylates containing up to 3 carbon atoms in the alkyl group and from non-acrylic monomers such as styrene and substituted styrenes, acrylonitrile, vinylchloride, and generally any compatible monomer the homopolymer of which has a T_{g} above 50° C. Preferred acrylic ester monomers are selected from alkyl acrylates and methacrylates containing 1 to 12 carbon atoms in the alkyl group, especially ethyl acrylate and butyl acrylate.

The cellulose-reactive emulsion copolymer will frequently contain, in addition to the main co-monomers, minor amounts of co-monomers which can provide cross-linking with both cellulose hydroxyl moieties within the cotton fibers and cross-linking within the copolymer itself. Such cross-linking co-monomers are unsaturated so as to polymerize into the copolymer backbone and will also contain at least one functional group containing nitrogen, oxygen or silicon atoms.

Thus the cellulose-reactive emulsion copolymers herein can comprise from about 0.1 wt % to about 10 wt %, based on total monomers in the copolymer, of one or more ethylenically unsaturated cross-linking co-monomers having, for example, at least one amide, epoxy, or alkoxysilane group. Examples of such suitable self cross-linking co-monomers include N-methylol (meth)acrylamide and esters therof, N-vinylpyrrolidinone, dimethylaminoethyl acrylate, glycidyl acrylate, glycidyl methacrylate, allyl glycidyl ether, vinyl glycidyl ether, acryloxy-propyltri(alkoxy)silanes, methacryloxypropyltri(alkoxy)silanes, vinyltrialkoxysilanes, vinylmethyldialkoxysilanes and combinations of these cross-linkable co-monomers.

The cellulose-reactive emulsion copolymer can also contain, in addition to the main co-monomers and self cross-linking co-monomers, minor amounts of multifunctional external cross-linking co-monomers. Thus the copolymers used herein can optionally comprise from about 0.1 wt % to about 10 wt %, based on total monomers in the copolymer, of one of more of these multifunctional cross-linking co-monomers. Examples of suitable multifunctional cross-linking co-monomers include diallyl adipate, triallyl cyanurate, butanediol diacrylate, allyl methacrylate and combinations thereof.

Cellulose-reactive emulsion copolymers used prior to dyeing to modify cotton warp yarn in accordance with the methods herein can frequently be selected from commercially available copolymer emulsions. Alternatively, suitable cellulose-reactive emulsion copolymers can be prepared in conventional fashion using known emulsion polymerization techniques and raw materials. In general, such emulsion copolymers can be prepared by polymerizing appropriate co-monomers in appropriate amounts in an aqueous reaction mixture using conventional polymerization initiators and catalysts and conventional polymerization conditions. The copolymer emulsions so prepared can be stabilized with suitable emulsifiers (surfactants) and/or protective colloids.

### Warp Yarn Pre-Treatment Conditions

The cellulose-reactive emulsion copolymers as described above are used to contact, pre-treat and chemically modify the cotton warp yarn material prior to an indigo dyeing operation. Such a procedure first involves contacting the cotton warp yarn and emulsion copolymer to prepare a warp yarn/copolymer combination. This warp yarn/copolymer combination is then subjected to curing which serves to chemically anchor the copolymer to the cotton fibers in the warp yarn via reaction with the hydroxyl groups of the cellulose component of the cotton fibers.

The cotton warp yarn material herein can be contacted with the cellulose-reactive emulsion copolymer by any suitable technique in order to form the copolymer-pretreated warp yarn. Such contact can generally involve treatment of the cotton warp yarn material with a treatment bath which can be made by diluting an aqueous emulsion copolymer dispersion to a solids content of from about 2.0 wt % to about 10 wt %, more preferably from about 3 wt % to about 6 wt %. Such treatment baths will also have a pH of from about 3 to about 7, more preferably from about 5 to about 7. Treatment temperature can range from about 45° C. to about 60° C.

Warp yarn can be treated with saturating liquors (called “pad baths”) with a nip roll squeeze after each bath saturation. Cotton warp yarn can also be treated in “package” form with the saturating liquor. Warp yarn can, in fact, be contacted with the pre-treating emulsion copolymer treatment bath using any techniques or equipment which are known in the art for applying liquid material to yarn to incorporate such additives as sizing, bleach or dye. Thus, for example, the cotton warp yarn can be emulsion copolymer-treated in a sizing machine, a rope dyeing machine, a slasher dyeing machine or a package dyeing machine.

Regardless of the method of application selected, application and processing conditions should be selected such that the cotton warp yarn material has a substantially uniform distribution of the emulsion copolymer associated with it. The warp yarn/copolymer combination will generally have a copolymer add-on of from about 1 wt % to about 10 wt %, more preferably from about 3 wt % to about 6 wt %, on a dry basis.

After the warp yarn/copolymer combination has been formed, this combination is subjected to curing conditions which are effective to chemically anchor the emulsion copolymer to the cotton fibrous material within the yarn via reaction of the copolymer with at least a portion of the hydroxyl moieties of the cellulose component of the cotton fibers. Such chemical reaction can occur via a cross-linking mechanism with the cross-linkable co-monomers which will generally form part of the emulsion copolymer as hereinbefore described. Curing of the fiber/copolymer combination also will generally promote some self-cross-linking of the copolymer within the fibrous cotton material or the warp yarn as well.

Curing conditions for the warp yarn/copolymer combination will generally involve subjecting the combination to elevated temperatures of from about 120° C. to about 150° C. for a period (dwell time) of from about 0.2 to about 4 minutes. More preferably, the warp yarn/copolymer combination can be cured by using temperatures of from about 130° C. to about 145° C. for a period (dwell time) of from about 0.3 to about 1 minute. In addition to anchoring the copolymer to the cellulose hydroxyl groups of the cotton fibers within the warp yarn, curing of the warp yarn/copolymer combination will also generally serve to remove water from this combination. Thus curing of the warp yarn/copolymer combination can serve to partially or even substantially completely dry the yarn/copolymer combination prior to the fabric formation and/or dyeing steps of the methods herein.

The treating of the cotton warp yarn material with the emulsion copolymer and the subsequent curing of the yarn/copolymer combination serves to provide chemically modified, copolymer-treated cotton yarn material. Such copolymer-treated cotton fibers can then be formed into denim fabric and dyed using the indigo dyestuff material and dyeing conditions hereinafter described.

### Denim Fabric Formation

In accordance with the methods herein, the emulsion copolymer pretreated cotton warp yarn as hereinbefore described, either before or after being dyed, is incorporated into cotton denim fabric. The weft or fill yarn also incorporated into the cotton denim fabric along with the emulsion copolymer-treated cotton warp yarn will comprise untreated cotton weft yarn. For purposes herein, the cotton weft yarn is “untreated” if it has not been modified by the emulsion copolymer treatment procedures hereinbefore described for the warp cotton yarn.

In the denim fabrics herein, not all of the warp yarn needs to be emulsion copolymer-treated cotton yarn and not all of the weft yarn needs to be untreated cotton yarn. Generally, at least 50% of the warp yarn in the fabric should be emulsion copolymer-treated cotton yarn and at least 50% of the weft yarn should be untreated cotton yarn. Preferably, however, substantially all of the warp yarn in the fabric should be emulsion copolymer-treated cotton yarn and substantially all of the weft yarn should be untreated cotton yarn.

Cotton warp and weft yarns can be fashioned into cotton denim fabrics in accordance with the methods herein by any conventional technique known for the preparation of such denim fabrics. The method herein is compatible with cotton denim fabrics having a wide range of fabric basis weights. Cotton denim fabrics will typically have a basis weight ranging from about 3 to about 10 oz/yd².

Weaving is a common method for making cotton yarn into cotton denim fabrics. The woven cotton denim fabrics which can be indigo dyed in accordance with the dyeing methods described hereinafter include, for example, those of a basic weave, satin weave, twill weave, ripstop weave or basket weave. Denim fabrics are most commonly of the twill weave type.

Cotton yarns can also be knitted to provide a variety of denim knit fabric types prior to being dyed in accordance with the dyeing method herein. Denim knit cotton fabrics will generally be of the warp type, including tricot knits or raschel knits.

### Indigo Dyeing Procedures

The emulsion copolymer-treated warp yarns as described herein, or cotton denim fabrics which comprise such emulsion copolymer-treated warp yarn, are dyed in accordance with the methods herein by contacting such yarns and/or fabrics with an indigo dyestuff material. Indigo has been used to dye fabric with “indigo blue” since before recorded history. Indigo has been used in India to dye fabric for at least 4,000 years by methods which are practically identical to the methods employed today. Indigo was introduced in Europe in large quantities by the Dutch East India Company in the early 17th century.

Indigo (C₁₆H₁₀N₂O₂) is the true coloring matter of indigo dye which is generically known as Vat Blue 1. When pure, indigo forms a dark, rich blue powder or bronzy blue-colored needle crystals. The most important reaction of indigo is its reaction with reducing agents. When subjected to a reducing agent in the presence of alkali, indigo combines with two atoms of hydrogen and is reduced to a colorless body, known as indigo-white or the leuco form, which is insoluble in water, but dissolves in alkali, with a yellow color. The lueco form of the indigo dye deposited onto cotton yarn is generally subjected to a “skying” process wherein the lueco form of the dye is oxidized with air to a blue indigo color.

The emulsion copolymer-treated warp yarn of the denim fabrics herein has a selective affinity for the indigo dyestuff material such that this emulsion copolymer-treated warp yarn can be indigo-dyed using an aqueous dye liquor comprising a dispersion of the indigo dyestuff material. Highly alkaline conditions are not needed to solubilize the indigo such that the aqueous dye liquor can therefore have a pH ranging from about 9 to less than about 12, more preferably from about 10 to about 11.

It is also not necessary to convert the indigo to the leuco form such that little or no reducing agents need be added to the aqueous dye liquor. The aqueous dye liquor (i.e., dye bath) can generally have a reduction/oxidation potential of from about −400 to about −600 mV.

The aqueous dye liquor used to color the cotton warp yarn material will comprise sufficient indigo dyestuff material such that contact of the dye liquor with the warp yarn or griege fabric to be dyed will provide an amount of dye of from about 15% to about 20% owg (on weight of goods). Lower concentrations of the indigo dye in the dye liquor are useful for tinting operations. Higher dye concentrations in the dye liquor, of course, produce dyed cotton denim fabrics and garments having more intense indigo color. Several passes of the yarn or fabric into contact with the dye bath may be used to achieve the desired intensity of color.

The aqueous dyeing liquor can optionally contain various fabric treating adjuvants besides the indigo dyestuff material. Such adjuvants can include, for example, optical brighteners, fabric softeners, antistatic agents, antibacterial agents, anti-wrinkling agents, ironing aids, flame-retardants, enzymes, uv stabilizers, anti-foaming agents, perfumes, and the like.

The aqueous dye liquor will generally be contacted with the cotton warp yarn material to be dyed at temperatures of from about 65° C. to about 100° C., more preferably from about 80° C. to about 95° C. Under such dyeing liquor temperature conditions, it is possible to carry out the dyeing procedures of the methods herein at atmospheric pressure.

In accordance with the dyeing method herein, the indigo dyestuff material as hereinbefore described is contacted with the copolymer-treated cotton warp yarn also hereinbefore described. Such contact can occur after the emulsion copolymer-treated cotton warp yarn has already been incorporated into the cotton denim fabric. Alternatively, the emulsion copolymer-treated cotton warp yarn can be contacted with the indigo dye liquor before this copolymer-treated cotton yarn is incorporated as warp yarn into the cotton denim fabrics herein.

No matter when the emulsion copolymer-treated warp yarn is contacted with the indigo dye liquor, such contacting should occur under conditions which are sufficient to affix at least a portion of the contacted indigo dyestuff material to the outer cross-sectional portions of the emulsion copolymer-treated cotton warp yarn. Such outer cross-sectional portions include primarily the outer, i.e., external, surface of the copolymer-treated cotton warp yarn. But the outer cross sectional portion of the yarn can also include the interior regions of the yarn in proximity to the outer surface thereof. The indigo dyestuff material, however, will generally not penetrate the copolymer-treated warp yarn material completely, i.e., all the way to the core of the yarn.

The methods herein thus provide an indigo-dyed yarn effect which is comparable to that of “ring-dyeing” as is described, for example, in U.S. Pat. No. 5,514,187. However, this “ring-dyeing” effect can be achieved with the methods herein with greater precision, more reproducibility, less waste and without the need to utilize hard to control dyeing and skying conditions of conventional ring-dyeing procedures.

In a preferred embodiment herein, the emulsion copolymer-treated cotton warp yarn is indigo-dyed after it has been woven or knitted into cotton denim fabric along with untreated cotton weft yarn to form griege denim fabric. Such griege denim fabric can then be dyed using a pad bath in continuous stenter (open width) frames or with batch processes such as, piece dyeing, jet, beck, jigger or paddle machines. Knit griege goods can be processed in the same machinery (both continuous and batch) as woven, just under different conditions.

The griege denim fabric can, of course, be fashioned into end use products such as garments, apparel, upholstery, linens, etc. prior to being contacted with the aqueous dispersion of the indigo dyestuff material and dyed. For garments, industrial garment washing machines may be used for dyeing. Optional dyeing application methods include manual processes such as spraying or manual wet add-on techniques. For dyeing of griege denim fabrics, garments or other end use articles, dye liquor to fabric ratios of from about 20:1 to about 8:1 can be employed.

Whatever dyeing techniques or apparatus are used for the indigo dying of the griege denim fabrics herein, the affinity of the copolymer-treated warp yarn in such griege fabrics will result in the indigo dye preferentially coloring the outer cross-sectional portions of the copolymer-treated warp yarn to a greater extent than the indigo dyestuff material colors the outer cross-sectional portions of the untreated cotton weft yarn. This results in the realization of indigo-dyed denim fabrics having a non-uniformly colored appearance.

As an optional step after the indigo dyeing of the griege denim fabrics as hereinbefore described, the resulting indigo-dyed denim fabric can be scoured to thereby preferentially remove indigo dye material which may have been to some extent deposited on the untreated cotton weft yarn within the dyed fabric. Also the indigo-dyed denim fabric may also optionally be further conventionally dyed by contacting the fabric with an additional dyestuff material of the indigo, vat, cationic, azoic, napthol, reactive, direct, sulfur, mordant, disperse or acid type.

In another embodiment, the emulsion copolymer-treated cotton warp yarn can be indigo dyed before it is incorporated into cotton denim fabric. Such indigo dyeing of the copolymer-treated cotton warp yarn can be carried out in the same type of sizing or dyeing apparatus which may be or may have been used for initial treatment of the warp yarn with the emulsion copolymer. Thus, prior to weaving or knitting of the copolymer-treated warp yarn into denim fabric, the treated warp yarn may be dyed in a sizing machine, a rope dyeing machine, a slasher dyeing machine or a package dyeing machine.

### Post-Dyeing Operations

The indigo-dyed cotton denim fabrics produced by the dyeing methods herein can be subjected to any conventional post-dyeing treatment. One such typical post-dyeing operation comprises a further wash down step which serves to remove a portion of dye from all or portions of the dyed fabric. Such a wash down operation gives even new fabrics or garments a fashionable worn or used appearance as, for example, with stone-washed denim blue jeans. Typical wash down techniques involve contacting the indigo-dyed fabrics with an abrasive material such as stones, perlite, pumice, sand and/or diatomaceous earth.

What is claimed is:

1. A method for preparing indigo-dyed denim fabric, which method comprises:
A) preparing emulsion copolymer-treated warp yarn by contacting cotton yarn with an emulsion copolymer and thereafter curing said copolymer to adhere said copolymer to the warp yarn;
B) weaving or knitting said emulsion copolymer-treated cotton warp yarn into denim fabric along with untreated cotton yarn as the weft yarn to thereby prepare griege denim fabric having emulsion copolymer-treated cotton warp yarn in the warp direction only; and thereafter
C) contacting said griege denim fabric with an aqueous dispersion of an indigo dyestuff material under conditions sufficient to preferentially color the outer cross-sectional portions of said emulsion copolymer-treated warp yarn to a greater extent than said indigo dyestuff material colors the outer cross-sectional portions of said untreated cotton weft yarn, to thereby provide indigo-dyed denim fabric having a non-uniformly colored appearance.

2. The method according to claim 1 which comprises an additional Step D) of scouring said non-uniformly colored indigo-dyed denim fabric to preferentially remove indigo dye material from the untreated cotton weft yarn within said fabric.

3. The method of claim 1 wherein said non-uniformly colored indigo-dyed denim fabric is subjected to further dyeing by contacting said fabric with an additional dyestuff material of the indigo, vat, cationic, azoic, napthol, reactive, direct, sulfur, mordant, disperse or acid type.

4. The method of claim 1 wherein said cotton warp yarn is emulsion copolymer-treated in a sizing machine, a rope dyeing machine, a slasher dyeing machine or a package dyeing machine.

5. The method according to claim 1 wherein the emulsion copolymer which is used to treat said cotton warp yarn is, prior to dilution in a yarn treatment bath, in the form of an emulsion having a solids content of from about 40 wt % to about 65 wt %, and a pH of from about 3 to about 7.

6. The method according to claim 1 wherein the emulsion copolymer which is used to treat said cotton warp yarn is, prior to contact with said yarn, diluted with water to form a yarn treatment bath having a solids content of from about 2.0 wt % to about 10 wt % and a pH for from about 3 to about 7.

7. The method according to claim 6 wherein said cotton warp yarn is contacted with said treatment bath at a temperature of from about 45° C. to about 60° C. and is then cured at a temperature of from about 120° C. to about 150° C.

8. The method according to claim 1 wherein the emulsion copolymer is selected from vinyl ester-based, acrylic-based, styrene/acrylic-based or styrene/butadiene-based emulsion copolymers.

9. The method according to claim 1 wherein the emulsion copolymer comprises a vinyl ester-based copolymer selected from vinyl acetate-ethylene copolymers, vinyl acetate-vinyl versatate copolymers; vinyl acetate-acrylic copolymers, and combinations of said copolymer types.

10. The method according to claim 1 wherein the emulsion copolymer comprises a vinyl acetate-ethylene copolymer comprising from about 60 wt % to about 95 wt % of vinyl acetate and from about 5 wt % to about 40 wt % of ethylene, based on total monomers therein.

11. The method according to claim 1 wherein the emulsion copolymer comprises an acrylic emulsion copolymer which comprises at least two different types of (meth)acrylate co-monomers.

12. The method according to claim 11 wherein the acrylic emulsion copolymer comprises ethyl acrylate and butyl acrylate co-monomers.

13. The method according to claim 1 wherein the emulsion copolymer comprises from about 0.1 wt % to about 10 wt %, based on total monomers in the copolymer, of one or more ethylenically unsaturated cross-linking co-monomers having at least one amide, epoxy, or alkoxysilane group.

14. The method according to claim 13 wherein the cross-linking co-monomers of the emulsion copolymer are self-cross-linking co-monomers selected from N-methylol (meth)acrylamide and esters therof, N-vinylpyrrolidinone, dimethylaminoethyl acrylate, glycidyl acrylate, glycidyl methacrylate, allyl glycidyl ether, vinyl glycidyl ether, acryloxy-propyltri(alkoxy)silanes, methacryloxypropyltri(alkoxy)silanes, vinyltrialkoxysilanes, vinylmethyldialkoxysilanes and combinations of said cross-linking co-monomers.

15. The method according to claim 1 wherein the emulsion copolymer comprises from about 0.1 wt % to about 10 wt %, based on total monomers in the copolymer, of one of more multifunctional external cross-linking co-monomers selected from diallyl adipate, triallyl cyanurate, butanediol diacrylate, allyl methacrylate, and combinations of said cross-linking co-monomers.

16. The method according to claim 1 wherein the indigo dye is contacted with said griege denim fabric via an aqueous dye liquor having a pH of from about 9 to less than about 12 and comprising an amount of indigo dyestuff material sufficient to provide 15 % to about 20 % owg of dye on fabric.

17. The method according to claim 1 wherein the griege denim fabric is fashioned into a garment prior to being contacted with said aqueous dispersion of said indigo dyestuff material.

18. The method according to claim 17 wherein, following its indigo dyeing, said garment is subjected to a washing step which removes a portion of dye from said dyed denim garment.

19. The method according to claim 18 wherein the washing step comprises contacting said dyed denim garment with stones, perlite, pumice and/or diatomaceous earth.

20. A method for preparing indigo-dyed denim fabric, which method comprises:
A) preparing emulsion copolymer-treated warp yarn by contacting cotton yarn with an emulsion copolymer and thereafter curing said copolymer to adhere said copolymer to the warp yarn;
B) contacting said emulsion copolymer-treated warp yarn with an aqueous dispersion of an indigo dyestuff material under conditions sufficient to color the outer cross-sectional portions of said emulsion copolymer-treated warp yarn; and
C) weaving or knitting said emulsion copolymer-treated, colored warp yarn into denim fabric along with untreated cotton yarn as the weft yarn to thereby prepare denim fabric having emulsion copolymer-treated, colored warp yarn in the warp direction only, to thereby provide indigo-dyed denim fabric having a non-uniformly colored appearance.

21. The method of claim 20 wherein said non-uniformly colored indigo-dyed denim fabric is subjected to further dyeing by contacting said fabric with an additional dyestuff material of the indigo, vat, cationic, azoic, napthol, reactive, direct, sulfur, mordant, disperse or acid type.

22. The method of claim 20 wherein said cotton warp yarn is emulsion copolymer-treated and then dyed in a sizing machine, a rope dyeing machine, a slasher dyeing machine or a package dyeing machine.

23. The method according to claim 20 wherein the emulsion copolymer which is used to treat said cotton warp yarn is, prior to dilution in a yarn treatment bath, in the form of an emulsion having a solids content of from about 40 wt % to about 65 wt %, and a pH of from about 3 to about 7.

24. The method according to claim 20 wherein the emulsion copolymer which is used to treat said cotton warp yarn is, prior to contact with said yarn, diluted with water to form a yarn treatment bath having a solids content of from about 2.0 wt % to about 10 wt % and a pH of from about 3 to about 7.

25. The method according to claim 24 wherein said cotton warp yarn is contacted with said treatment bath at a temperature of from about 45° C. to about 60° C. and is then cured at a temperature of from about 120° C. to about 150° C.

26. The method according to claim 20 wherein the emulsion copolymer is selected from vinyl ester-based, acrylic-based, styrene/acrylic-based or styrene/butadiene-based emulsion copolymers.

27. The method according to claim 20 wherein the emulsion copolymer comprises a vinyl ester-based copolymer selected from vinyl acetate-ethylene copolymers, vinyl acetate-vinyl versatate copolymers; vinyl acetate-acrylic copolymers, and combinations of said copolymer types.

28. The method according to claim 20 wherein the emulsion copolymer comprises s a vinyl acetate-ethylene copolymer comprising from about 60 wt % to about 95 wt % of vinyl acetate and from about 5 wt % to about 40 wt % of ethylene, based on total monomers therein.

29. The method according to claim 20 wherein the emulsion copolymer comprises an acrylic emulsion copolymer which comprises at least two different types of (meth)acrylate co-monomers.

30. The method according to claim 20 wherein the acrylic emulsion copolymer comprises ethyl acrylate and butyl acrylate co-monomers.

31. The method according to claim 20 wherein the emulsion copolymer comprises from about 0.1 wt % to about 10 wt %, based on total monomers in the copolymer, of one or more ethylenically unsaturated cross-linking co-monomers having at least one amide, epoxy, or alkoxysilane group.

32. The method according to claim 31 wherein the cross-linking co-monomers of the emulsion copolymer comprise self-cross-linking co-monomers selected from N-methylol (meth)acrylamide and esters therof, N-vinylpyrrolidinone, dimethylaminoethyl acrylate, glycidyl acrylate, glycidyl methacrylate, allyl glycidyl ether, vinyl glycidyl ether, acryloxy-propyltri(alkoxy)silanes, methacryloxypropyltri(alkoxy)silanes, vinyltrialkoxysilanes, vinylmethyldialkoxysilanes and combinations of said cross-linking co-monomers.

33. The method according to claim 31 wherein the cellulose-reactive emulsion copolymer comprises from about 0.1 wt % to about 10 wt %, based on total monomers in the copolymer, of one of more multifunctional external cross-linking co-monomers selected from diallyl adipate, triallyl cyanurate, butanediol diacrylate, allyl methacrylate, and combinations of said cross-linking co-monomers.

34. The method according to claim 20 wherein the indigo dye is contacted with said emulsion copolymer-treated cotton warp yarn via an aqueous dye liquor having a pH of from about 9 to less than about 12 and comprising an amount of indigo dyestuff material sufficient to provide 15% to about 20% owg of dye on yarn.

35. The method according to claim 20 wherein the denim fabric is fashioned into a garment prior to being subjected to further dyeing.

36. The method according to claim 20 wherein said fabric is subjected to a washing step which removes a portion of dye from said dyed denim fabric.

37. The method according to claim 36 wherein the washing step comprises contacting said dyed denim garment with stones, perlite, pumice and/or diatomaceous earth.

38. Indigo-dyed cotton denim fabric prepared according to the method of claim 1.

39. Indigo-dyed cotton denim fabric prepared according to the method of claim 20.

40. Indigo-dyed cotton denim fabric comprising a plurality of cotton warp yarns and a plurality of cotton weft yarns, said cotton warp yarns being treated with a cellulose reactive emulsion copolymer and then contacted with an aqueous dispersion of an indigo dyestuff material under conditions sufficient to color the outer cross-sectional portions of said emulsion copolymer-treated cotton warp yarns; and said cotton weft yarns being untreated prior to optional contact of said cotton weft yarns with an aqueous dispersion of indigo dyestuff material.
